(19) United States
(12) Patent Application Publication
(10) Pub. No.: US 2007/0082317 A1
(43) Pub. Date: Apr. 12, 2007

(54) Atomization apparatus of a washing machine for washing a human cavity tissue

(75) Inventor: Chung-Ming Chuang, Antin Hsiang (TW)

Correspondence Address: NIKOLAI & MERSEREAU, P.A., 900 SECOND AVENUE SOUTH, SUITE 820, MINNEAPOLIS, MN, 55402, US

(73) Assignee: Ya Horng Electronic Co., Ltd., Antin Hsiang (TW)

(21) Appl. No.: 11/247,911

(22) Filed: Oct. 11, 2005

(51) Int. Cl. A61C 17/02

(52) U.S. Cl. 433/80

(57) ABSTRACT

A spray element of an irrigator includes a support shank and a sleeve. The support shank has a hollow channel and an end wall having an inside formed with at least two water outlet holes and an outside formed with a gathering portion and at least two trenches each connected to a respective one of the water outlet holes and the gathering portion. The sleeve has an end wall rested on the end wall of the support shank and formed with a nozzle connected to the gathering portion. When the fluid flowing in each of the trenches impacts mutually, the fine spray is generated and ejected outwardly from the nozzle of the sleeve.

### BACKGROUND OF THE INVENTION

1. Field of the Invention

The present invention relates to a spray element, and more particularly to a spray element of an irrigator for washing human cavity tissues, such as the oral cavity or nasal cavity of a human body.

2. Description of the Related Art

A conventional oral irrigator in accordance with the prior art shown in FIGS. 9 and 10 comprises a main body 1, a water tank 11 mounted on the main body 1, a water conveying device (not shown) mounted in the main body 1 and having its water inlet connected to the water outlet of the water tank 1 1, a switch 15 mounted on the main body 1 in charge of switching on the water conveying device, a connecting hose 12 mounted on the main body 1 and having its inlet connected to the water outlet of the water conveying device, a handle 13 mounted on the main body 1 and having its inlet connected to the outlet of the connecting hose 12, and a jet tip 14 attached to the outlet of the handle 13 to eject a strong water beam outwardly to cleanse a user's oral cavity or tartar on the user's teeth so as to achieve an oral cleansing effect. The jet tip 14 has an inside formed with a taper channel 141 to pressurize the water flow.

In operation, the fluid stored in the water tank 11 is conducted by the water conveying device to flow through the connecting hose 12 and the handle 13 into the jet tip 14 and then ejected outwardly from the taper channel 141 of the jet tip 14.

However, the strong water beam ejected from the taper channel 141 of the jet tip 14 impacts the user's oral cavity strongly, thereby easily causing an uncomfortable sensation to the user. In addition, when the user infuses medical liquid into the water tank 11 for the purpose of curing the wound in his oral cavity, the strong water beam ejected from the taper channel 141 of the jet tip 14 easily hurts the wound due to high hydraulic pressure.

### SUMMARY OF THE INVENTION

In accordance with the present invention, there is provided a spray element comprising a support shank and a sleeve. The support shank has a hollow channel formed inside and an end wall formed at the end of the outlet body. The end wall of the support shank has an inside formed with at least two water outlet holes each connected to the hollow channel and has an outside formed with a gathering portion and at least two trenches each having a first end connected to a respective one of the water outlet holes and a second end connected to the gathering portion. The sleeve mounted on the outlet body of the support shank has a nozzle connected to the gathering portion of the support shank.

The primary objective of the present invention is to provide a spray element of an irrigator for washing human cavity tissues, such as the oral cavity or nasal cavity of a human body.

Another objective of the present invention is to provide a spray element, wherein the fluid is ejected outwardly from the nozzle of the sleeve in fine spray.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a spray element of an irrigator in accordance with the preferred embodiment of the present invention.

FIG. 2 is an exploded perspective view of the spray element as shown in FIG. 1.

FIG. 3 is a partially enlarged plan view of the end wall of the support shank of the spray element as shown in FIG. 2.

FIG. 4 is a partially enlarged plan cross-sectional assembly view of the spray element as shown in FIG. 2.

FIG. 5 is a perspective view of a spray element of an irrigator in accordance with another preferred embodiment of the present invention.

FIG. 6 is an exploded perspective view of the spray element as shown in FIG. 5.

FIG. 7 is a partially enlarged plan cross-sectional assembly view of the spray element as shown in FIG. 6.

FIG. 8 is a perspective view of a spray element of an irrigator in accordance with another preferred embodiment of the present invention.

FIG. 9 is a perspective view of a conventional oral irrigator in accordance with the prior art.

FIG. 10 is a partially enlarged plan cross-sectional view of the conventional oral irrigator as shown in FIG. 9.

### DETAILED DESCRIPTION OF THE INVENTION

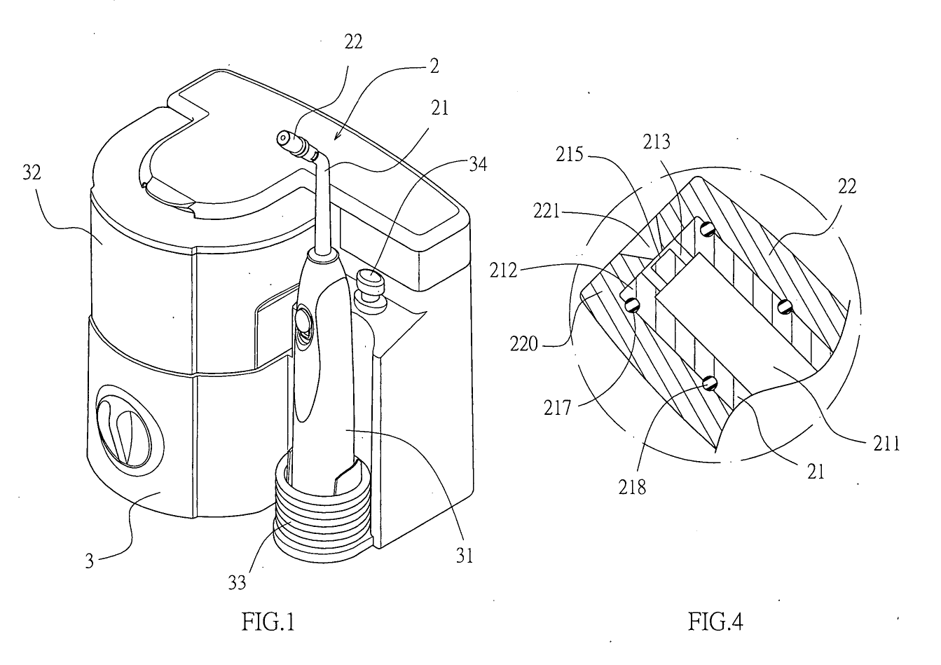

Referring to the drawings and initially to FIG. 1, an irrigator in accordance with the preferred embodiment of the present invention comprises a main body 3, a water tank 32 mounted on the main body 3, a water conveying device (not shown) mounted in the main body 3 and having its water inlet connected to the water outlet of the water tank 32, a switch 34 mounted on the main body 3 in charge of switching on the water conveying device, a connecting hose 33 mounted on the main body 3 and having its inlet connected to the water outlet of the water conveying device, a handle 31 mounted on the main body 3 and having its inlet connected to the outlet of the connecting hose 33, and a spray element 2 removably attached to the outlet of the handle 31 to eject water outwardly.

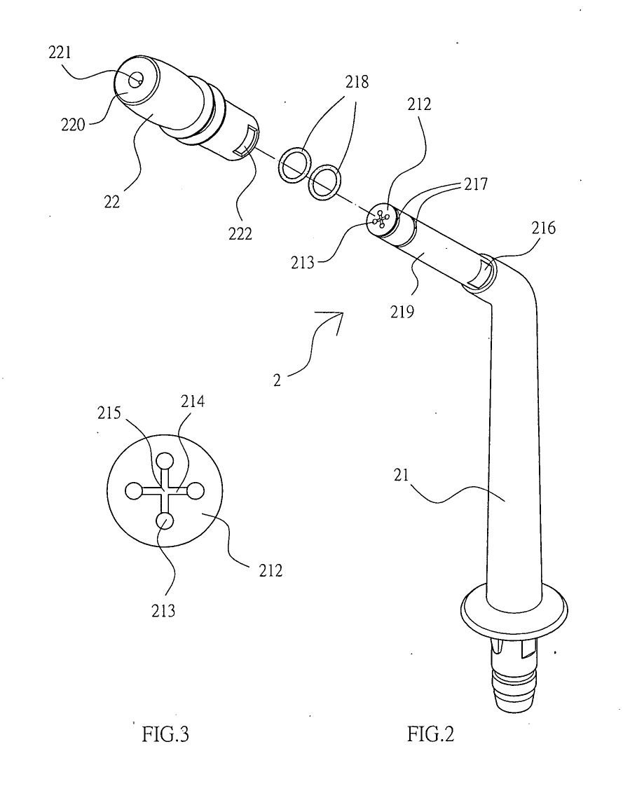

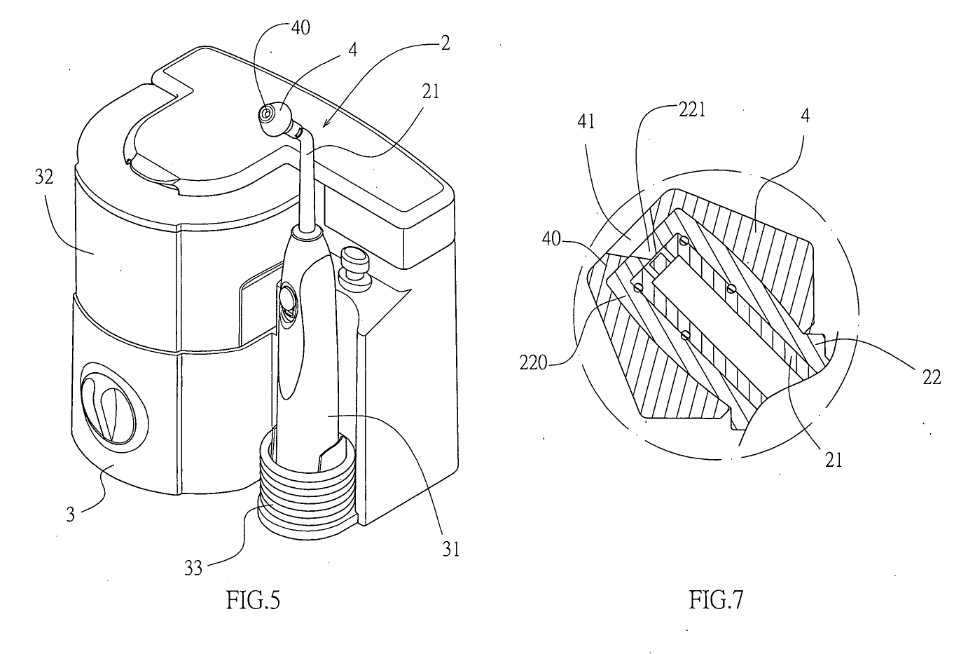

Referring to FIGS. 1-4, the spray element 2 of the irrigator in accordance with the preferred embodiment of the present invention comprises a substantially V-shaped support shank 21 and a sleeve 22.

The support shank 21 has a hollow channel 211 formed inside and an end wall 212 formed at the end of the outlet body 219. The end wall 212 has an inside formed with at least two water outlet holes 213 each connected to the hollow channel 211 and has an outside formed with a gathering portion 215 and at least two trenches 214 each having a first end connected to a respective one of the water outlet holes 213 and a second end connected to the gathering portion 215. Preferably, the support shank 21 has four symmetrically arranged water outlet holes 213 each extended in the axial direction of the end wall 212 and four symmetrically arranged trenches 214 each extended in the transverse direction of the end wall 212.

The sleeve 22 mounted on the outlet body 219 of the support shank 21 is a resilient hollow body that has a conical nozzle 221 penetrating through the end wall 220.

When the sleeve 22 is mounted on outlet body 219 of the support shank 21, the inner side of the end wall 220 of the sleeve 22 abuts against the outside of the end wall 212 of the support shank 21 to seal the open outside of each of the trenches 214 of the end wall 212 so as to limit the fluid in each trench 214 to flow along the determined direction.

In operation, the fluid stored in the water tank 32 is conducted by the water conveying device to flow through the connecting hose 33 and the handle 31 into the hollow channel 211 of the support shank 21, and then flows to the outlet holes 213 to be guided into the corresponding trenches 214. At this time, the fluid flowing in each of the trenches 214 is pressurized under the operation of the water conveying device, so when the fluid from each of the trenches 214 is guided into the gathering portion 215, the fluid from the trenches 214 impacts mutually to form fine spray, and the fine spray is finally ejected outwardly from the nozzle 221 of the sleeve 22 evenly and smoothly.

The fluid ejected outwardly from the nozzle 221 of the sleeve 22 is in fine spray state, so it is proper to use in gentle way to cleanse a user's cavity tissue, such as nasal cavity. In addition, after infusing medical liquid into the water tank 11, the user can use the spray element 2 to eject the medical liquid in fine spray to curing the wound in his oral or nasal cavity softly.

The sleeve 22 has a peripheral wall formed with at least a locking slot 222, and the support shank 21 has a peripheral wall formed with at least a corresponding locking hook 216 snapped into and locked in the locking slot 222 of the sleeve 22, so the sleeve 22 is fixed on the support shank 21 closely. The spray element 2 further comprises at least one O-ring 218 urged between the sleeve 22 and the support shank 21 to provide a sealing effect. The peripheral wall of the support shank 21 is formed with at least one retaining groove 217 for retaining the O-ring 218.

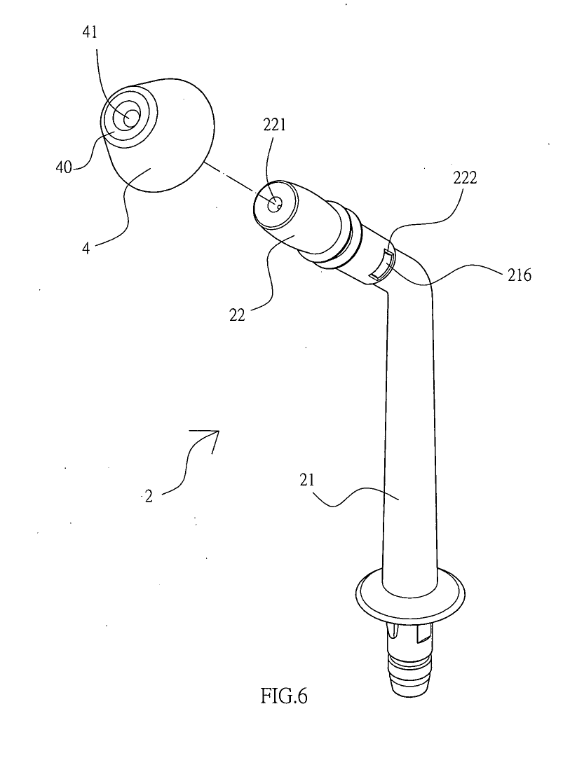

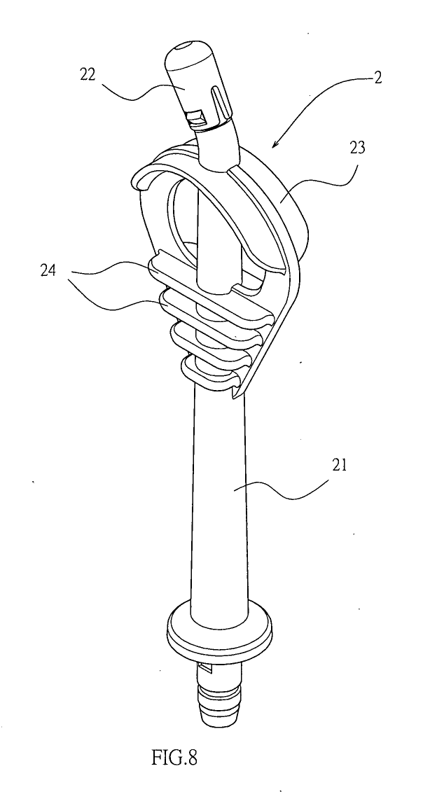

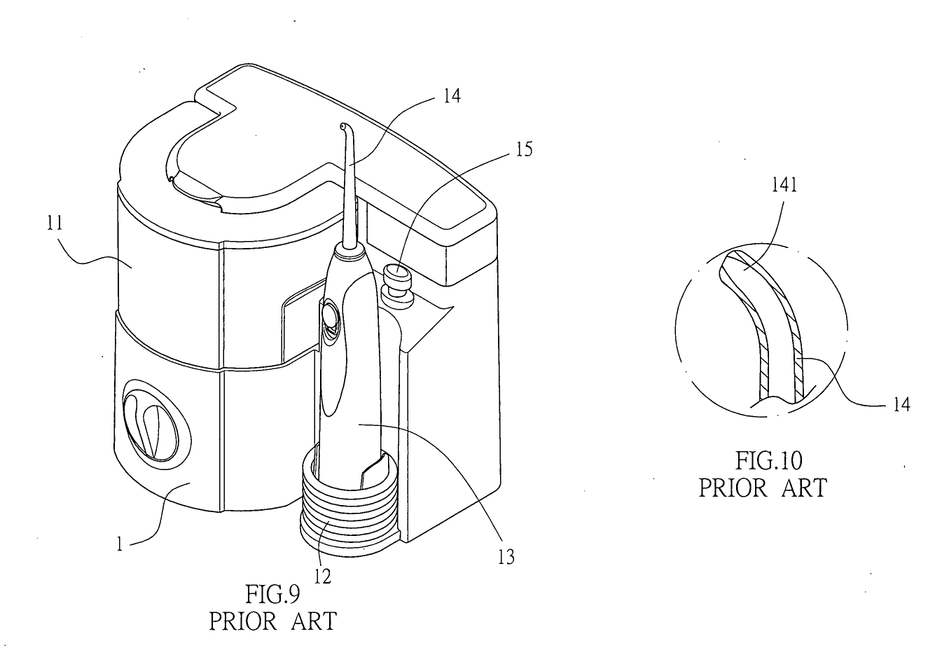

Referring to FIGS. 5-7, the spray element 2 further comprises a substantially conical plug 4 mounted on the sleeve 22 and having an end wall 40 rested on the end wall 220 of the sleeve 22 and formed with a water outlet hole 41 connected to the nozzle 221 of the sleeve 22. Because the plug 4 can block the user's nose easily, it keeps the spray element 2 to eject fine spray into the user's nose steady.

Referring to FIG. 8, the spray element 2 further comprises a substantially arc-shaped scraper 23 mounted on the support shank 21 so as to facilitate the user to scrape his tongue conveniently. Furthermore, there mounted on the support shank 21 are a plurality of ribs 24 which can serve as auxiliary scrapers to increase the effect of cleaning fur on the user's tongue.

Although the invention has been explained in relation to its preferred embodiment(s) as mentioned above, it is to be understood that many other possible modifications and-variations can be made without departing from the scope of the present invention. It is, therefore, contemplated that the appended claim or claims will cover such modifications and variations that fall within the true scope of the invention.

What is claimed is:

1. A spray element of an irrigator for washing human cavity tissues, comprising a support shank and a sleeve, wherein:
the support shank has a hollow channel formed inside and an end wall formed at the end of the outlet body;
the end wall of the support shank has an inside formed with at least two water outlet holes each connected to the hollow channel and has an outside formed with a gathering portion and at least two trenches each having a first end connected to a respective one of the water outlet holes and a second end connected to the gathering portion;
the sleeve removably mounted on the outlet body of the support shank has an end wall and a nozzle penetrating through the end wall.

2. A spray element in accordance with claim 1, wherein the nozzle of the sleeve is substantially in conical shape.

3. A spray element in accordance with claim 1, wherein the nozzle of the sleeve is connected to the gathering portion of the support shank.

4. A spray element in accordance with claim 1, wherein each outlet hole extends in the axial direction of the end wall of the support shank.

5. A spray element in accordance with claim 1, where each trench extends in the transverse direction of the end wall of the support shank.

6. A spray element in accordance with claim 1, wherein the sleeve is a resilient hollow body.

7. A spray element in accordance with claim 1, wherein the fluid is ejected outwardly from the nozzle of the sleeve in fine spray.

8. A spray element in accordance with claim 1, wherein the sleeve has a peripheral wall formed with at least a locking slot, and the support shank has a peripheral wall formed with at least a corresponding locking hook.

9. A spray element in accordance with claim 1, further comprising at least one O-ring urged between the sleeve and the support shank.

10. A spray element in accordance with claim 9, wherein the support shank has a peripheral wall formed with at least one retaining groove for retaining the O-ring.

11. A spray element in accordance with claim 1, further comprising a plug mounted on the sleeve.

12. A spray element in accordance with claim 11, wherein the plug is substantially in conical shape.

13. A spray element in accordance with claim 11, wherein the plug and the sleeve are integrally formed.

14. A spray element in accordance with claim 11, wherein the plug has an end wall rested on the end wall of the sleeve and formed with a water outlet hole connected to the nozzle of the sleeve.

15. A spray element in accordance with claim 1, further comprising a scraper mounted on the support shank.

16. A spray element in accordance with claim 15, wherein the scraper is substantially is arc shape.

17. A spray element in accordance with claim 1, further comprising a plurality of ribs mounted on the support shank.
